(19) United States
(12) Patent Application Publication
(10) Pub. No.: US 2026/0274394 A1
(43) Pub. Date: Sep. 17, 2026

(54) AIRCRAFT DOOR ASSEMBLY WITH DECOMPRESSION PANELS

(71) Applicant: Adams Rite Aerospace Inc., Fullerton, CA (US)

(72) Inventor: Morteza Yadollahi, Fullerton, CA (US)

(21) Appl. No.: 19/566,307

(22) Filed: Mar. 13, 2026

Related U.S. Application Data
(60) Provisional application No. 63/772,268, filed on Mar. 14, 2025.

(51) Int. Cl. B64C 1/14; B64C 1/10; B64C 1/00

(52) U.S. Cl. CPC B64C 1/1469; B64C 1/10; B64C 2001/009

(57) ABSTRACT

An aircraft door includes a body defining a first body aperture therein and a primary panel pivotably attached to the body and configured to pivot between first and second positions, wherein when the primary panel is in the first position, the primary panel partially encloses the first body aperture, and wherein the primary panel has a first panel aperture defined therein. The aircraft door also includes a secondary panel pivotably attached to the primary panel and configured to pivot between first and second positions, wherein when the secondary panel is in the first position, the secondary panel encloses the first panel aperture.

### CROSS-REFERENCE TO RELATED APPLICATIONS

This application claims the benefit of U.S. Provisional Patent Application No. 63/772,268, filed March 14, 2025, which is incorporated herein by reference.

### FIELD OF THE INVENTION

The present invention relates generally to an aircraft door, and more particularly to an aircraft door having nested panels, which are selectively pivotable to promote pressure equilibration within the aircraft.

### BACKGROUND

With reference to FIG. 1, commercial aircrafts 10 include fuselage with various regions defined therein. For example, first and second regions may be defined therein, where the first region is a cockpit 20 (or flight deck, nearest a nose of the aircraft), where the pilot(s) reside during flight, and the second region is a cabin 30 intended to seat the passengers and flight attendants, with a partition or bulkhead 40 disposed therebetween. The bulkhead 40 includes a door 50 to permit ingress/egress for the pilot(s) between the cockpit 20 and the cabin 30. Due to various regulations and requirements set by the Federal Aviation Administration (“FAA”), at least the door 50 (and possibly the bulkhead 40) is required to be ballistic resistant, or otherwise capable of resisting threatening intrusions. Additionally, the door 50 is required to permit pressure equalization between the cockpit 20 and the cabin 30 in various decompression events, often brought on by structural failure and/or inadvertent impact.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized to provide a an aircraft door including a body defining a first body aperture therein, and a primary panel pivotably attached to the body and configured to pivot between first and second positions. When the primary panel is in the first position, the primary panel partially encloses the first body aperture. Also, the primary panel has a first panel aperture defined therein. The aircraft door further includes a secondary panel pivotably attached to the primary panel and configured to pivot between first and second positions. When the secondary panel is in the first position, the secondary panel encloses the first panel aperture.

In another embodiment, a cockpit door for an aircraft is provided and includes a body having first and second surfaces facing opposite first and second directions, respectively, wherein a body aperture is defined within the body. The cockpit door further includes a primary panel having a panel aperture defined therein and being pivotably attached to the body between first and second positions, wherein the primary panel has opposite first and second surfaces, wherein when the primary panel is in the first position, the second surface thereof is disposed adjacent the first surface of the body. The cockpit door also includes a secondary panel pivotably attached to the body, independently of the primary panel, between first and second positions, wherein the secondary panel has opposite first and second surfaces, and wherein when the secondary panel is in the first position, the first surface of the secondary panel is disposed adjacent the first surface of the primary panel and the secondary panel fully conceals the panel aperture. When the primary and secondary panels are in their respective first positions, the primary panel and the secondary panel collectively fully enclose the body aperture, and wherein when the primary and secondary panels pivot to their respective second positions, from their respective first positions, the primary and secondary panels pivot in the first and second directions, respectively.

### BRIEF DESCRIPTION OF THE DRAWINGS

FIG. 1 is a schematic, top view of a select section of an aircraft;

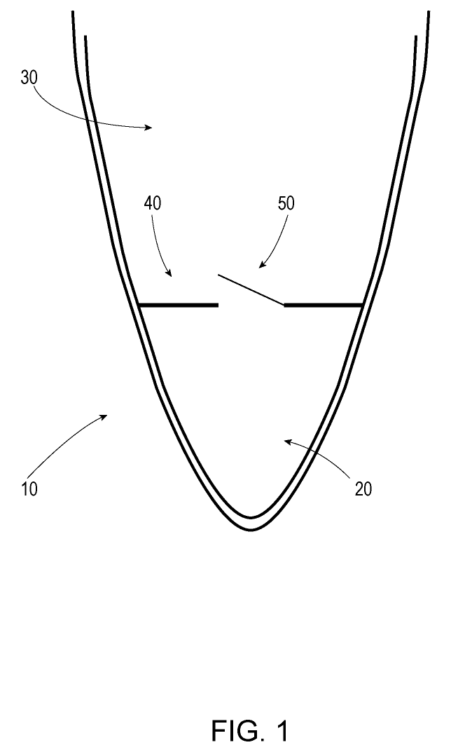

FIG. 2 is a perspective view of the aircraft, depicting a bulkhead partitioning a cockpit and a cabin, and a door permitting selective access therebetween;

FIG. 3 is a perspective, exploded view of the door depicted in FIG. 2;

FIG. 4 is a rear view of a primary panel of the door depicted in FIG. 3;

FIG. 5 is a perspective view of the door with the primary panels shown in an opened configuration; and

FIG. 6 is another perspective view of the door, depicting secondary panels thereof in an opened configuration.

### DETAILED DESCRIPTION

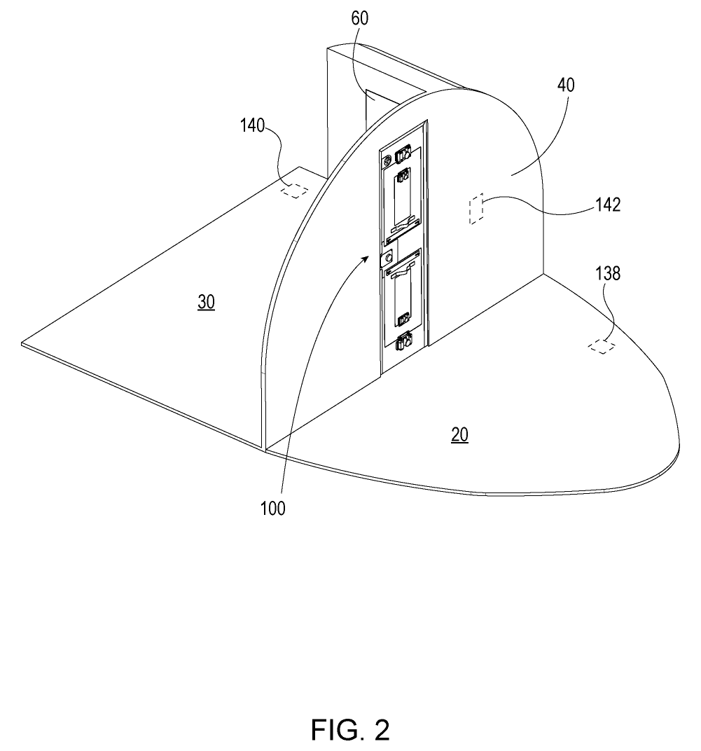

Conventional doors 50 that provide access between the cockpit 20 and the cabin 30 are often located adjacent to a lavatory located within the cabin 30 and are configured to swing open such that the non-hinged edge of the door 50 moves towards a door 60 of the lavatory (e.g., as shown in FIG. 2). During decompression events, some conventional aircrafts are configured such that the door 50 swings open to equalize the pressure between the cockpit 20 and the cabin 30. Due to the pressure differential, the door 50 may be forced into contact with the lavatory door 60, potentially damaging the same, or even trapping an occupant within the lavatory.

In view of the above, a cockpit door is provided that safely permits two-way pressure equalization, securely maintains a fully closed position (i.e., so as to not inadvertently contact the surrounding environment in either the cockpit 20 or the cabin 30) and that meets FAA regulations and requirements relating to safety.

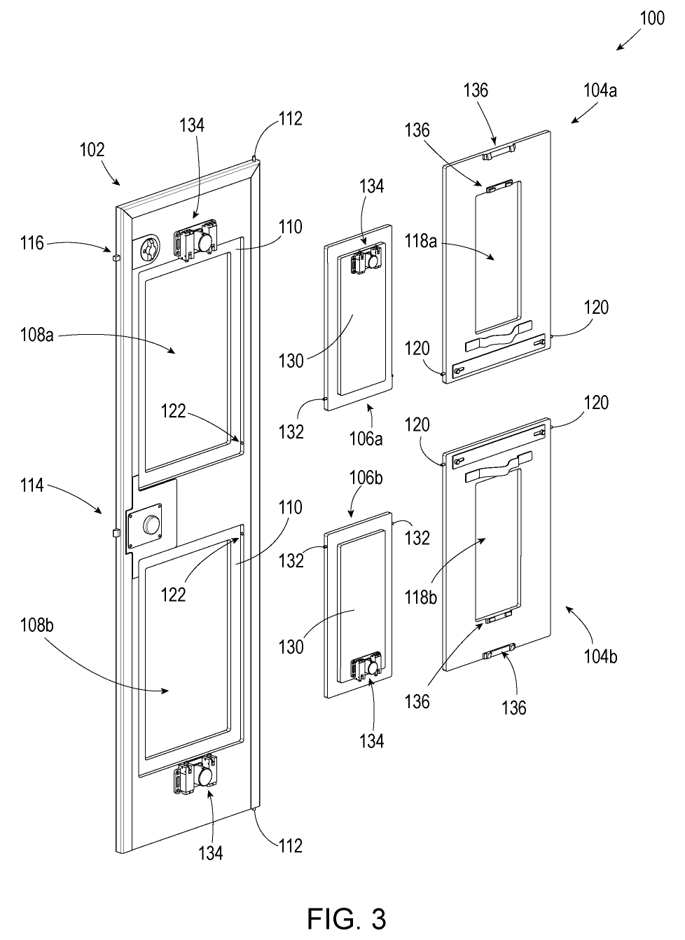

Briefly, with reference to FIG. 2, a cockpit door 100 is shown in a closed position relative to the bulkhead 40 that separates the cockpit 20 from the cabin 30. Now with reference to FIG. 3, the cockpit door 100 is shown in an exploded view and includes a body 102, a pair of primary panels (i.e., hereinafter referred to as first and second primary panels 104a, 104b), and a pair of secondary panels (i.e., hereinafter referred to as first and second secondary panels 106a, 106b). Of note, while the depicted embodiment and the below disclosure relates to the cockpit door 100 having two primary and secondary panels, it is to be understood that the cockpit door 100 may have more or less primary and secondary panels. For example, the cockpit door 100 may include only a single primary panel (and corresponding secondary panel) or may include three (or more) of each of the primary and secondary panels. Additionally, not every primary panel need necessarily be associated with a corresponding secondary panel, so long as at least one primary panel is associated with a corresponding secondary panel.

As depicted, the body 102 includes a first and second body apertures 108a, 108b (i.e., through-holes) formed therein, wherein the first body aperture 108a is vertically disposed above the second body aperture 108b. However, in other embodiments, the first and second body apertures 108a, 108b may be disposed laterally adjacent to one another. As further shown, a front surface of the body 102 is debossed (i.e., recessed) at each of the first and second body apertures 108a, 108b to thereby define respective flanges 110, each circumscribing its corresponding (first or second) body aperture 108a, 108b. As used herein, the “front surface” of the body 102 is the surface (or side) facing the cockpit 20 when closed, whereas a “rear surface” of the body 102 is the opposite surface (or side), which faces the cabin 30 when closed.

The cockpit door 100 further includes a pair of pivot pins 112 located at top and bottom edges of the body 102 which permit the cockpit door 100 to pivot when connected to a door frame of the bulkhead 40. As is conventional, the pivot pins 112 are located adjacent a first lateral edge of the body 102, whereas a door knob 114 (and associated latching mechanisms) is provided adjacent a second (opposite) lateral edge of the body 102. The door knob 114 itself may have locking features that prevent inadvertent or forceful entry from the cabin 30 into the cockpit 20. Additionally, the cockpit door 100 further includes a dedicated lock 116 (e.g., a deadbolt, etc.) provided at the second lateral edge of the body 102 for enhanced security.

As briefly mentioned above, the cockpit door 100 further includes the first and second primary panels 104a, 104b, each associated with a corresponding one of the apertures 108a, 108b. More specifically, the first and second primary panels 104a, 104b are planar bodies, each sized and shaped complimentary to the debossed area associated with its (first or second) body aperture 108a, 108b, as will be described more fully below. As shown, the first and second primary panels 104a, 104b have first and second panel apertures 118a, 118b (i.e., through-holes) formed respectively therein. As will be further discussed below, when the cockpit door 100 is in an assembled state, the first panel aperture 118a of the first primary panel 104a aligns (i.e., is coaxial) with the first body aperture 108a formed in the body 102, and the second panel aperture 118b of the second primary panel 104b aligns (i.e., is coaxial) with the second body aperture 108b formed in the body 102. Notably, the first and second panel apertures 118a, 118b are shaped and sized so as to be smaller than their corresponding first and second body apertures 108a, 108b. In other words, no portion of the body 102 impedes on the coaxial window defined by the first panel aperture 118a and the first body aperture 108a or that of the second panel aperture 118b and the second body aperture 108b.

As further shown, each of the first and second primary panels 104a, 104b includes a pair of pivot pins 120 located at opposite lateral edges thereof. More specifically, the pivot pins 120 of the first primary panel 104a are provided adjacent a bottom edge thereof and are configured to be received within corresponding pin holes 122 (e.g., bores) formed in a peripheral wall that circumscribes the flange 110 associated with the first body aperture 108a. Additionally, the pivot pins 120 of the second primary panel 104b are provided adjacent a top edge thereof and are configured to be received within corresponding pin holes 122 formed in a peripheral wall that circumscribes the flange 110 associated with the second body aperture 108b. In this manner, the first primary panel 104a is pivotably connected to the body 102 about its bottom edge to move between first and second positions (described further below), and the second primary panel 104b is pivotably connected to the body 102 about its top edge to move between first and second positions (described further below). However, it is to be understood that other configurations are contemplated. For example, each of the first and second primary panels 104a, 104b may be pivotably connected to the body 102 at its edge furthest from a central area of the cockpit door 100. Further still, it is contemplated that each of the first and second primary panels 104a, 104b may be pivotably connected to the body 102 at one of its lateral (i.e., right or left) edges.

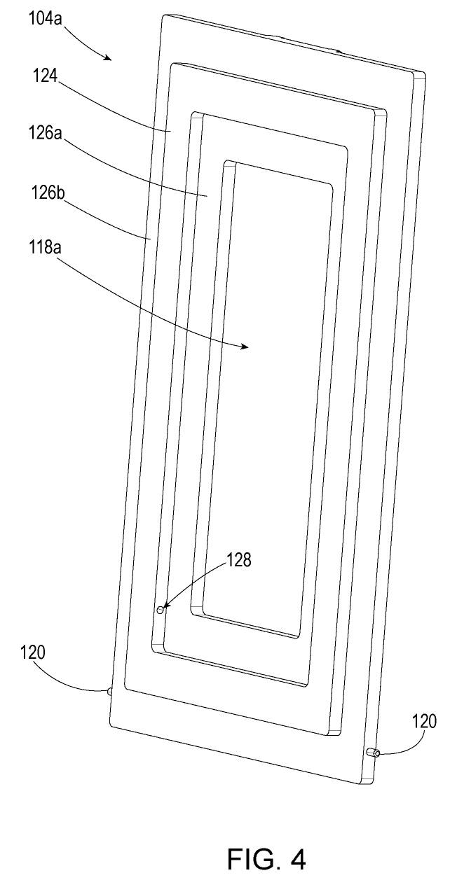

Briefly moving to FIG. 4, a rear view of the first primary panel 104a is shown, wherein a rear surface of the first primary panel 104a includes a protrusion 124 standing proud therefrom and circumscribing the first panel aperture 118a. More specifically, the protrusion 124 partitions the rear surface of the first primary panel 104a into first and second sections 126a, 126b, wherein the first section is encircled by the protrusion 124, and wherein the second section 126b is disposed outside of the protrusion 124. Notably, the first and second sections 126a, 126b of the rear surface are coplanar. Further, pin holes 128 are formed in the protrusion 124 at (internal) lateral walls that face one another. The pin holes 128 are located near the bottom edge of the first primary panel 104a and are configured to receive corresponding pivot pins of first secondary panel 106a, as will be described further below. Of note, while the above disclosure regarding FIG. 4 is directed towards the first primary panel 104a, it is to be understood that said disclosure likewise applies to the second primary panel 104b, albeit the pin holes 128 formed in the second primary panel 104b are located near a top edge thereof.

Moving back to FIG. 3, each of the first and second secondary panels 106a, 106b includes a centrally located projection 130 standing proud from a planar (front) surface thereof, wherein that projection is sized and shaped complimentary to the corresponding (first or second) panel aperture 118a, 118b so as to be receivable therein. Further, each of the first and second secondary panels 106a, 106b includes a pair of pivot pins 132 located at and projecting from lateral edges thereof. Notably, the pivot pins 132 of the first secondary panel 106a are located adjacent a bottom edge thereof, whereas the pivot pins 132 of the second secondary panel 106b are located adjacent a top edge thereof. The pivot pins 132 associated with the first and second secondary panels 106a, 106b are configured to be received in the corresponding pin holes 128 formed in the first and second primary panels 104a, 104b, respectively, to permit the first and second secondary panels 106a, 106b to pivot (between first and second positions) relative to the first and second primary panels 104a, 104b.

As noted above, each of the first and second primary panels 104a, 104b and the first and second secondary panels 106a, 106b is pivotable between first and second positions. As will be further discussed below, the first primary panel 104a and the first secondary panel 106a are pivotable independently of one another, and the second primary panel 104b and the second secondary panel 106b are pivotable independently of one another. Briefly moving back to FIG. 2, each of the first and second primary panels 104a, 104b and the first and second secondary panels 106a, 106b is shown in a first (i.e., closed) position. The relative structural positioning between the body 102, the first primary panel 104a, and the first secondary panel 106a when in the first position will now be discussed. It is to be understood that the same or similar positioning likewise applies to the second primary panel 104b and the second secondary panel 106b when in the first position.

When the cockpit door 100 is fully assembled (and when the panels are in the first position), the first secondary panel 106a is pivotably coupled to the first primary panel 104a such that it is disposed directly adjacent the rear surface thereof and circumscribed by the protrusion 124. Notably, seals, gaskets, or the like (not shown) may be employed to ensure an appropriate seal is created between the first primary panel 104a and the first secondary panel 106a when the latter is in its first position. For example, a gasket may be provided on the first section 126a of the rear surface of the first primary panel 104a (i.e., said surface being depicted in FIG. 4). Moreover, when the first secondary panel 106a is in the first position, the projection 130 of the first secondary panel 106a extends into the first panel aperture 118a so as to enclose that aperture. Notably, the front surface of the projection 130 and the front surface of the first primary panel 104a may be coplanar when the first secondary panel 106a is in the first position. Due to the sizing of the first primary panel 104a and the first secondary panel 106a, the first section 126a of the rear surface of the first primary panel 104a acts as a backstop such that the first secondary panel 106a is only permitted to pivot (from the first position) in a single direction, as described further below. In other words, when the first secondary panel 106a is in its first position, the first section 126a of the rear surface of the first primary panel 104a prevents the first secondary panel 106a from pivoting into the cockpit-side 20 of the aircraft.

Moreover, the first primary panel 104a is pivotably coupled to the body 102 such that it is disposed directly adjacent the front surface thereof and received within the debossed area associated with the first body aperture 108a (when in its first position). Again, seals, gaskets, or the like (not shown) may be employed to ensure an appropriate seal is created between the first primary panel 104a and the body 102 when the former is in its first position. For example, a gasket may be provided on a front surface of the flange 110.

As shown in FIG. 2, when the first primary panel 104a and the first secondary panel 106a are in their respective first positions, the first primary panel 104a and the first secondary panel 106a collectively enclose the first body aperture 108a. In other words, because of the first panel aperture 118a, the first primary panel 104a itself only partially encloses the first body aperture 108a when in its first position. With this said, when the first secondary panel 106a is also in its first position, the first secondary panel 106 fully encloses and conceals the first panel aperture 118a, thereby fully enclosing (and concealing) the first body aperture 108a. That same is true for the second primary panel 104b and the second secondary panel 106b. Of note, the front surface of the first primary panel 104a (and that of the first secondary panel 106a) may be coplanar with the front surface of the body 102 when said panels are in their respective first positions. Moreover, due to the sizing of the first primary panel 104a, the flange 110 acts as a backstop such that the first primary panel 104a is only permitted to pivot (from the first position) in a single direction (opposite to the pivoting action of the first secondary panel 106a), as described below. In other words, when the first primary panel 104a is in its first position, the flange 110 prevents the first primary panel 104a from pivoting into the cabin-side 30 of the aircraft.

Briefly moving back to FIG. 3, each of the first primary panel 104a and the first secondary panel 106a is associated with a corresponding locking mechanism to lock those panels in their corresponding first position. For example, a lock 134 (having a mechanically translatable bolt) is provided on each of the body 102 and the first secondary panel 106a that (selectively) engages with (and secures to) a corresponding bracket 136 provided on the first primary panel 104a. Indeed, the same applies to the second primary panel 104b and the second secondary panel 106b, as shown. The locks 134 may be physically (mechanically) operated (i.e., via user interaction) or may be operated under electronic control, as will be described below.

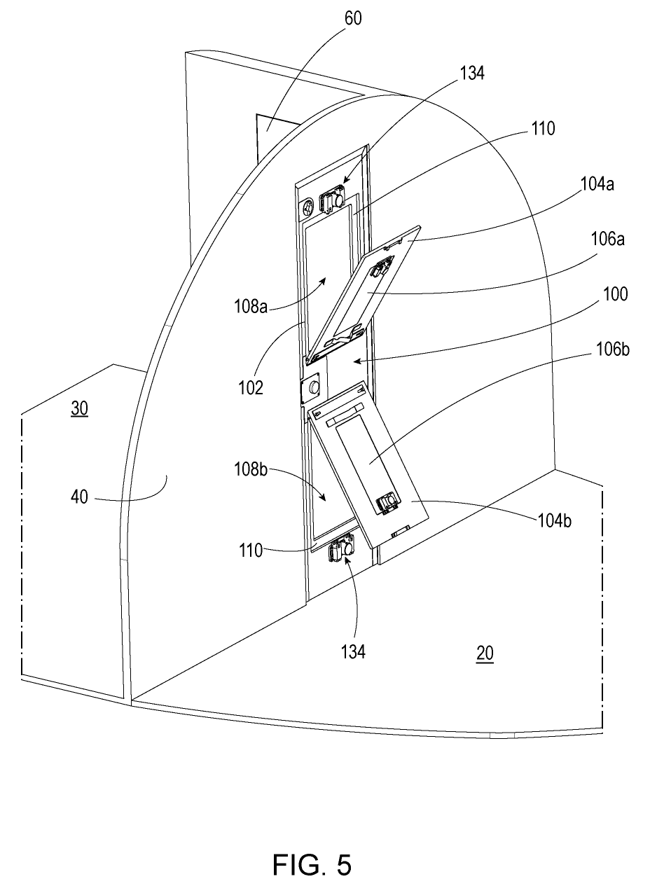

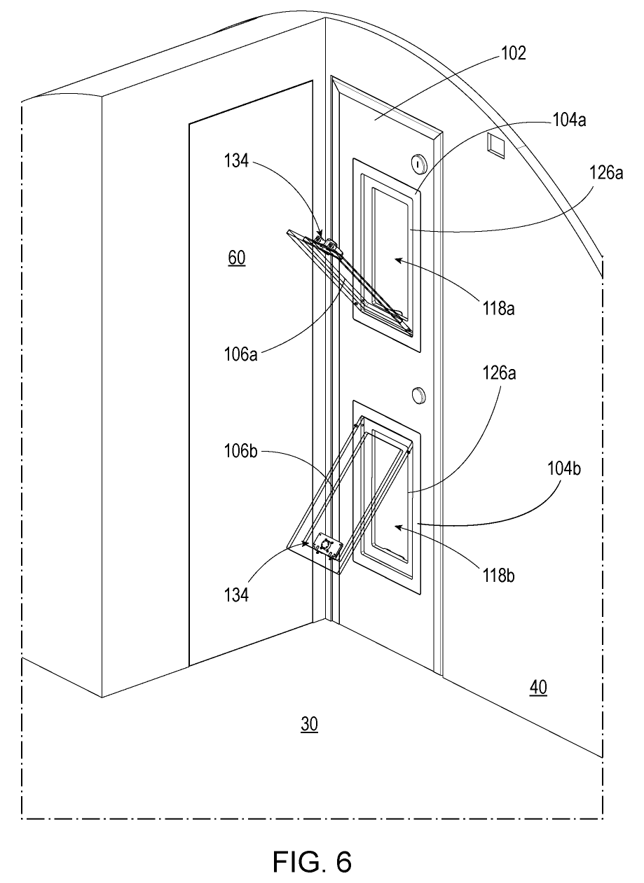

Now moving on to FIG. 5, the second position of the first primary panel 104a will be discussed with the understanding that the below disclosure likewise applies to the second primary panel 104b. When the lock 134 on the body 102 is in a disengaged orientation (and therefore not secured to the corresponding bracket located on the first primary panel 104a), the first primary panel 104a is pivotable in a first direction (i.e., a front direction or into the cockpit 20). Notably, as the first primary panel 104a pivots, the first body aperture 108a is revealed (i.e., no longer covered or concealed) thereby permitting significant fluid communication between the cockpit 20 and the cabin 30 for pressure equilibration, as discussed further below. Now with reference to FIG. 6 (depicting a view of the cockpit door 100 from inside the cabin 30), the second position of the first secondary panel 106a will be discussed with the understanding that the below disclosure likewise applies to the second secondary panel 106b. When the lock 134 on the first secondary panel 106a is in a disengaged orientation (and therefore not secured to the corresponding bracket located on the first primary panel 104a), the first secondary panel 106a is pivotable in a second direction (i.e., a rear direction or into the cabin 30). Notably, as the first secondary panel 106a pivots, the first panel aperture 118a is revealed (i.e., no longer covered or concealed), thereby permitting significant fluid communication between the cockpit 20 and the cabin 30. Indeed, as shown, when the first secondary panel 106a is in the second (opened) position, the first primary panel 104a is in the first (closed) position, and may be locked in said position by the corresponding lock 134 and bracket 136.

The above-described cockpit door 100 includes the primary panels 104a, 104b and the secondary panels 106a, 106b that are configured to independently pivot open in opposite directions. More specifically, the primary panels 104a, 104b pivot open into the cockpit-side 20 of the aircraft, whereas the secondary panels 106a, 106b pivot open into the cabin-side 30 of the aircraft. This configuration permits pressure equilibration between the cockpit 20 and the cabin 30 regardless of where the decompression event occurs.

When the aircraft is in flight, it is intended for the cockpit 20 and the cabin 30 to remain at the same pressure. However, a pressure differential between these two partitioned areas may occur due to unforeseen events. When that pressure differential is detected, the various panels of the cockpit door 100 can pivot to their corresponding second positions to equalize the pressure. For example, with reference to FIG. 2, a first pressure sensor 138 is provided within the cockpit 20 and a second pressure sensor 140 is provided within the cabin 30. Each of the first and second pressure sensors 138, 140 detects the pressure within its segregated zone and transmits those detected readings to a controller 142. The controller 142 compares the readings to determine whether a pressure differential occurs and controls the locking orientations of the locks 134 to permit/prohibit the various panels to pivot from the first position to the second position.

Under normal operating conditions when the aircraft is in flight, where the pressure within the cockpit 20 (detected by the first pressure sensor 138) is the same as (or substantially the same as) the pressure within the cabin 30 (detected by the second pressure sensor 140), each of the locks 134 is oriented in its locking orientation so as to prohibit each of the first and second primary panels 104a, 104b and each of the first and second secondary panels 106a, 106b from pivoting from the first position to the second position. However, when the controller 142 identifies a pressure differential, the controller 142 can actuate select ones of the locks 134 to permit pivoting of the first and second primary panels 104a, 104b or the first and second secondary panels 106a, 106b, depending on where decompression occurs.

For example, in the event of decompression within the cockpit 20 (e.g., due to a crack in the windshield, etc.), the controller 142 will sense the pressure differential (noting that the decompression event is associated with the cockpit 20) and actuate (i.e., release) the locks 134 associated with the first and second primary panels 104a, 104b, such that those panels pivot into the cockpit 20 (in accordance with and due to the pressure differential), as shown in FIG. 5. In doing so, the first and second body apertures 108a, 108b in the body 102 are unveiled, and pressure equilibration can occur between the cockpit 20 and cabin 30. Notably, if the controller determines that the decompression event is associated with the cockpit 20, as in the example above, the locks 134 associated with the first and second secondary panels 106a, 106b will remain in their locked orientation, thereby prohibiting the first and second secondary panels 106a, 106b to pivot relative to the first and second primary panels 104a, 104b, respectively. Separately, in the event of decompression within the cabin 30, the controller 142 will sense the pressure differential (noting that the decompression event is associated with the cabin 30) and actuate (i.e., release) the locks 134 associated with the first and second secondary panels 106a, 106b, such that those panels pivot into the cabin 30 (in accordance with and due to the pressure differential), as shown in FIG. 6. In doing so, the first and second panel apertures 118a, 118b in the first and second primary panels 104a, 104b are unveiled, and pressure equilibration can occur between the cockpit 20 and cabin 30. Notably, if the controller determines that the decompression event is associated with the cabin 30, as in the example directly above, the locks 134 associated with the first and second primary panels 104a, 104b will remain in their locked orientation, thereby prohibiting the first and second primary panels 104a, 104b to pivot (from the first position) relative to the body 102 of the cockpit door 100.

The above-described configuration not only provides for two-way pressure equalization, dependent on where the decompression event occurs, but also permits equilibration without having to open the cockpit door 100. Accordingly, meaningful interference between the cockpit door 100 and the lavatory door 60 (or other surrounding objects) will not occur during decompression events. Also, the cockpit door 100 as described can be manufactured using light weight unidirectional aramid fiber technology so as to comply with FAA regulations. Further, in the event that the cockpit door 100 itself malfunctions (i.e., unable to pivot open) or if the surrounding environment prohibits the cockpit door 100 to pivot, then the primary panels 104a, 104b could be used as a means for ingress/egress between the cockpit 20 and the cabin 30.

The invention has been described with reference to example embodiments. Modifications and alterations thereto will be evident to persons of skill in the art upon a reading and understanding this specification.

What is claimed is:

1. An aircraft door, comprising:
a body defining a first body aperture therein;
a primary panel pivotably attached to the body and configured to pivot between first and second positions, wherein when the primary panel is in the first position, the primary panel partially encloses the first body aperture, and wherein the primary panel has a first panel aperture defined therein; and
a secondary panel pivotably attached to the primary panel and configured to pivot between first and second positions, wherein when the secondary panel is in the first position, the secondary panel encloses the first panel aperture.

2. The aircraft door of claim 1, wherein when the primary panel pivots from the first position to the second position, the primary panel pivots in a first direction, wherein when the secondary panel pivots from the first position to the second position, the secondary panel pivots in a second direction, and wherein the first direction is opposite to the second direction.

3. The aircraft door of claim 1, wherein the primary panel is a first primary panel, and the aircraft door further comprises a second primary panel pivotably attached to the body and configured to pivot between first and second positions, wherein when the second primary panel is in the first position, the second primary panel partially encloses a second body aperture defined in the body.

4. The aircraft door of claim 3, wherein when the first primary panel pivots from the first position to the second position, the first primary panel pivots in a first direction, wherein when the second primary panel pivots from the first position to the second position, the second primary panel pivots in the first direction.

5. The aircraft door of claim 4, wherein the secondary panel is a first secondary panel, and the aircraft door further comprises a second secondary panel pivotably attached to the second primary panel and configured to pivot between first and second positions, wherein when the second secondary panel is in the first position, the second secondary panel encloses a second panel aperture defined in the second primary panel.

6. The aircraft door of claim 5, wherein when the second secondary panel pivots from the first position to the second position, the second secondary panel pivots in a second direction, opposite to the first direction.

7. The aircraft door of claim 1, wherein a recess is formed on a first surface of the body to define a flange circumscribing the first body aperture, and wherein the primary panel is seated within the recess when in the first position.

8. The aircraft door of claim 7, wherein when the primary panel is in the first position, the primary panel is received within the recess and disposed adjacent the flange.

9. The aircraft door of claim 8, wherein the primary panel has opposite, first and second surfaces, wherein the first surface of the primary panel and the first surface of the body face a first direction, and wherein a protrusion extends from the second surface of the primary panel in a second direction opposite to the first direction.

10. The aircraft door of claim 9, wherein when the secondary panel is in the first position, the protrusion circumscribes the secondary panel.

11. The aircraft door of claim 1, wherein each of the body, the primary panel, and the secondary panel has opposite, first and second surfaces, wherein said first surfaces face a first direction, and wherein said second surfaces face an opposite, second direction.

12. The aircraft door of claim 11, wherein when the primary panel is in the first position, the second surface of the primary panel is disposed adjacent the first surface of the body, and wherein when the secondary panel is in the first position, the first surface of the secondary panel is disposed adjacent the second surface of the primary panel.

13. The aircraft door of claim 1, wherein the primary panel and the secondary panel are pivotable between their respective first and second positions independently of one another.

14. The aircraft door of claim 1, further comprising first and second locks, wherein the first lock is configured to lock the primary panel in the first position, and wherein the second lock is configured to lock the secondary panel in the first position.

15. An aircraft, comprising:
a fuselage;
a bulkhead that partitions an inside of the fuselage into first and second regions; and
the aircraft door of claim 1, located at the bulkhead so as to provide selective access between the first and second regions.

16. The aircraft of claim 15, wherein when the primary panel pivots from the first position to the second position, the primary panel pivots into the first region, and wherein when the secondary panel pivots from the first position to the second position, the secondary panel pivots into the second region.

17. The aircraft of claim 16, wherein the first region is a cockpit and the second region is a cabin.

18. The aircraft door of claim 1, wherein when the primary and secondary panels are in their respective first positions, the primary panel and the secondary panel collectively fully enclose the first body aperture.

19. A cockpit door for an aircraft, the cockpit door comprising:
a body having first and second surfaces facing opposite first and second directions, respectively, wherein a body aperture is defined within the body;
a primary panel having a panel aperture defined therein and being pivotably attached to the body between first and second positions, wherein the primary panel has opposite first and second surfaces, wherein when the primary panel is in the first position, the second surface thereof is disposed adjacent the first surface of the body; and
a secondary panel pivotably attached to the body, independently of the primary panel, between first and second positions, wherein the secondary panel has opposite first and second surfaces, and wherein when the secondary panel is in the first position, the first surface of the secondary panel is disposed adjacent the first surface of the primary panel and the secondary panel fully conceals the panel aperture,
wherein when the primary and secondary panels are in their respective first positions, the primary panel and the secondary panel collectively fully enclose the body aperture, and wherein when the primary and secondary panels pivot to their respective second positions, from their respective first positions, the primary and secondary panels pivot in the first and second directions, respectively.
